(19) United States
(12) Patent Application Publication
(10) Pub. No.: US 2006/0177354 A1
(43) Pub. Date: Aug. 10, 2006

(54) Apparatus for processing biological sample

(75) Inventor: David Daf, Taipei (TW)

Correspondence Address: LADAS & PARRY, 26 WEST 61ST STREET, NEW YORK, NY, 10023, US

(73) Assignee: TAIGEN BIOSCIENCE CORPORATION

(21) Appl. No.: 11/051,903

(22) Filed: Feb. 4, 2005

(51) Int. Cl. B01L 9/00

(52) U.S. Cl. 422/102

(57) ABSTRACT

An apparatus for processing biological sample which are commonly used to wash, separate and purify biochemical molecules, such as DNA, RNA and protein. The apparatus comprises at least one liquid semi-permeable membrane column, at least one vacuum connected column and a vacuum manifold, which are all loosely received to each other. An air tight material such as an air tight elastic band is disposed at a position where the liquid semi-permeable membrane column, the one vacuum connected column and the vacuum manifold engage with each other, thereby when the atmospheric pressure in the liquid semi-permeable membrane column is larger than that in the vacuum manifold, the apparatus is formed and maintained in an air tight state. If a liquid sample is placed inside liquid semi-permeable membrane column, the atmospheric pressure can push the liquid out of the column through the liquid semi-permeable membranes. It is therefore much easier and convenient to assemble and disassemble the apparatus than a conventional one.

### BACKGROUND OF THE INVENTION

1. Field of the Invention

The present invention relates to an apparatus for processing biological sample, especially the apparatus used to wash, separate and purify biochemical molecules, such as DNA, RNA and protein.

2. Description of the Related Art

In biology laboratories, liquid semi-permeable membrane columns, which are generally cylindrical, are commonly used to wash, separate and purify biochemical molecules, such as DNA, RNA and protein. One or more pieces of specific purpose liquid semi-permeable membranes are placed at the bottom of the column and liquid is poured into the column. An adequate force is then applied to the liquid in the column, pushing the liquid out of the column through the liquid semi-permeable membranes.

Normally, the force applied is either a centrifugal force or atmospheric pressure. When a centrifugal force is applied through the liquid semi-permeable membrane column, the column is usually placed into a liquid collecting tube, and the liquid is then poured into the liquid semi-permeable membrane column. The column and the liquid collecting tube are then placed into a centrifuge and spun at high speed generating a high centrifugal force which in turn, the liquid is pushed out of the column through the liquid semi-permeable membranes and is collected in the liquid collecting tube. However, it is a hassle for an operator to repeat the above procedure several times during continuous washing of the liquid semi-permeable membrane column. When atmospheric pressure is applied, several liquid semi-permeable membrane columns are inserted into a vacuum manifold. By applying positive or negative atmospheric pressure, the liquid is pushed out of the columns through the liquid semi-permeable membranes and is collected in the vacuum manifold. The atmospheric pressure procedure is more convenient to operate for multiple samples or continuous operations.

Closer inspection of the liquid semi-permeable membrane column (see FIG. 1) shows that it is a geometric design consisting of three parts: an upper cervical section 311, a middle tubular section 312 and a lower tapered section 313. The diameter of the upper cervical section 311 is larger than that of the middle tubular section 312. Some of the columns contain a lid 314. The middle tubular section 312 is filled with liquid sample, and its interior bottom part contains one or more specific purpose liquid semi-permeable membranes (not shown in the figure). Some of them have a design of lower tapered sections 313, but some of them do not.

As shown in FIG. 1, the traditional engagement of the liquid semi-permeable membrane column 31 with a vacuum manifold 32 is of a tight insertion style, i.e. the lower tapered section 313 of the liquid semi-permeable membrane column 31 is directly inserted or through an insertable vacuum connected column 33 into a hole 34 of the vacuum manifold 32. The insertable vacuum connected column 33 is used to avoid the direct insertion of the liquid semi-permeable membrane column 31 into the hole 34 of the vacuum manifold 32, as the hole 34 of the vacuum manifold 32 may contact any liquid semi-permeable membrane column with different samples, which in turn, can lead to cross contamination of different samples. The insertable vacuum connected column 33 can be of a disposable type or simply cleaned for repeated use. When using the insertable vacuum connected column 33, the lower tapered section 313 of the liquid semi-permeable membrane column 31 is inserted into the insertable vacuum connected column 33. Then this ensemble is inserted to the hole 34 of the vacuum manifold 32 which in turn, forms the following structure: the liquid semi-permeable membrane column 31—the insertable vacuum connected column 33—the vacuum manifold 32. Many applications utilise the insertable vacuum connected column 33, especially experiments which require no cross contamination of the samples, such as using purified nuclear acid for PCR reaction. It is therefore very important that this engagement must be tightly secured to avoid any gas leak. Often, the operator has to hand-hold the liquid semi-permeable membrane column 31 and the insertable vacuum connected column 33 to ensure tight engagement. It is likely that the operator may experience discomfort of fingers due to this manoeuvre. On the other hand, the engagement sometimes can be difficult to disengage if it is too tight, and the multiple engagement sometimes can be difficult to operate, making it inconvenient to use the liquid semi-permeable membrane columns for multiple samples.

For the above-mentioned reasons, the applicant provides an apparatus comprising loosely engaged liquid semi-permeable membrane column, vacuum connected column and vacuum manifold for processing biological samples, whereas the operator can use this apparatus in a speedy and comfortable way.

### SUMMARY OF THE INVENTION

It is an object of the present invention to provide an apparatus for processing biological sample which is easier and convenient to assemble and disassemble. The apparatus comprises at least one liquid semi-permeable membrane column, at least one vacuum connected column and a vacuum manifold, which are all loosely fit to each other. An air tight material, such as an air tight elastic band, is disposed at a position where the liquid semi-permeable membrane column, the one vacuum connected column and the vacuum manifold engage with each other, thereby when the atmospheric pressure in the liquid semi-permeable membrane column is larger than that in the vacuum manifold, the apparatus is formed and maintained in an air tight state. If a liquid sample is placed inside liquid semi-permeable membrane column, the atmospheric pressure can push the liquid out of the column through liquid semi-permeable membranes.

The liquid semi-permeable membrane column comprises an inner section, a top section and a bottom section. The inner section defines a first receiving space with at least one liquid semi-permeable membrane placed at the bottom thereof. The top section is formed with a first aperture and has a first protrusion extending outwards from the top section. The bottom section is formed with a first through hole.

The vacuum connected column comprises an inner section, a top section and a bottom section. The inner section defines a second receiving space. The top section is formed with a second aperture and has a second protrusion extending outwards from the top section. The bottom section is formed with a second through hole. The vacuum manifold comprises a base defining a receiving space and a lid having at least one slot extending downwards therefrom for receiving at least one vacuum connected column. The slot is formed with a third through hole in communication with the receiving space of the base.

The liquid semi-permeable membrane column is loosely received in the second receiving space of the vacuum connected column such that the first protrusion of the liquid semi-permeable membrane column abuts against the second protrusion of the vacuum connected column. An air tight element, such as an air tight elastic band, is disposed around the periphery of the second protrusion. The vacuum connected column is loosely received in the slot such that the second protrusion abuts against an upper surface of the lid around the edge of the slot, and the first, the second and the third through holes are in communication, thereby when the atmospheric pressure in the first receiving space of the liquid semi-permeable membrane column is larger than that in the slot of the vacuum manifold, an air tight state is maintained between the first protrusion of the liquid semi-permeable membrane column and the second protrusion of the vacuum connected column, and between the second protrusion of the vacuum connected column and the upper surface of the lid around the edge of the slot.

In the other embodiment according to the present invention, an air tight element is sandwiched between the bottom section of the vacuum connected column and a bottom of the slot such that when the atmospheric pressure in the first receiving space of the liquid semi-permeable membrane column is larger than that in the slot of the vacuum manifold, an air tight state is formed and maintained between the first protrusion of the liquid semi-permeable membrane column and the second protrusion of the vacuum connected column, and between the bottom section of the vacuum connected column and the bottom of the slot. In addition, the liquid semi-permeable membrane column can also engage the vacuum manifold directly and an air tight element can be disposed around the periphery of the first protrusion or sandwiched between the bottom section of the liquid semi-permeable membrane column and the bottom of the slot to achieve the same air tight effect.

Other objects, advantages and novel features of the present invention will be drawn from the following detailed description of preferred embodiments of the present invention with the accompanying drawings, in which:

### DESCRIPTION OF THE DRAWINGS

FIG. 1 illustrates a schematic view of a conventional apparatus for processing biological sample;

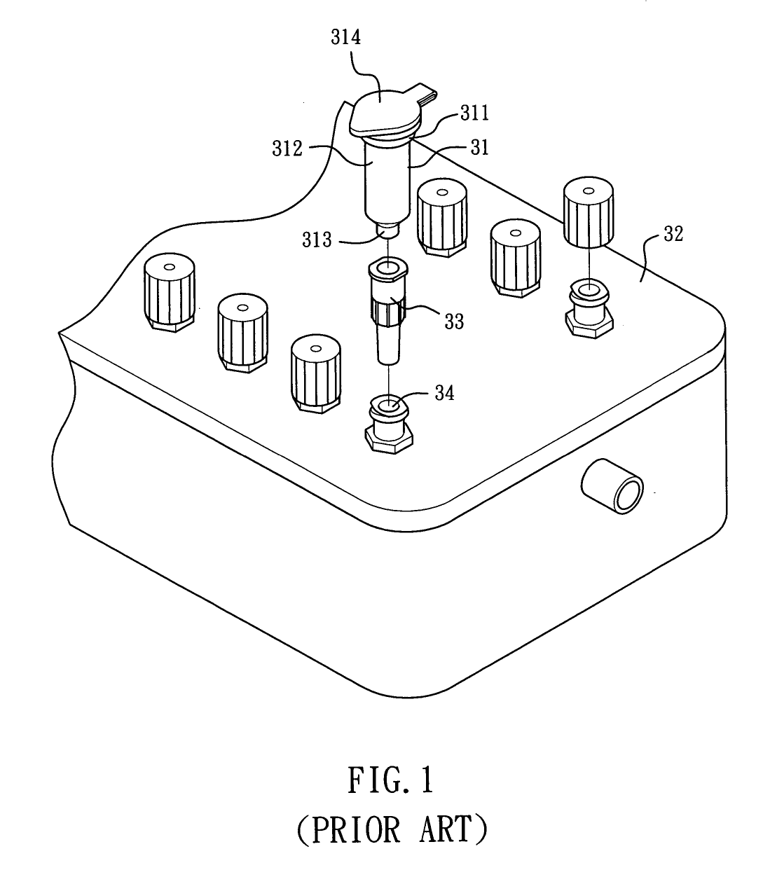

FIG. 2 illustrates a schematic view of a conventional liquid semi-permeable membrane column used in conjunction with a vacuum connected column according to the present invention;

FIG. 3 illustrates a perspective view of an apparatus for processing biological sample according to the present invention;

FIG. 4 illustrates a cross-sectional view of FIG. 3;

FIG. 5 illustrates a perspective view of an alternative embodiment of the apparatus according to the present invention;

FIG. 6 illustrates a cross-sectional view of FIG. 5;

FIG. 7 illustrates a perspective view of an alternative embodiment of the apparatus according to the present invention;

FIG. 8 illustrates a cross-sectional view of FIG. 7;

FIG. 9 illustrates a perspective view of an alternative embodiment of the apparatus according to the present invention; and

FIG. 10 illustrates a cross-sectional view of FIG. 9.

### DETAILED DESCRIPTION OF THE INVENTION

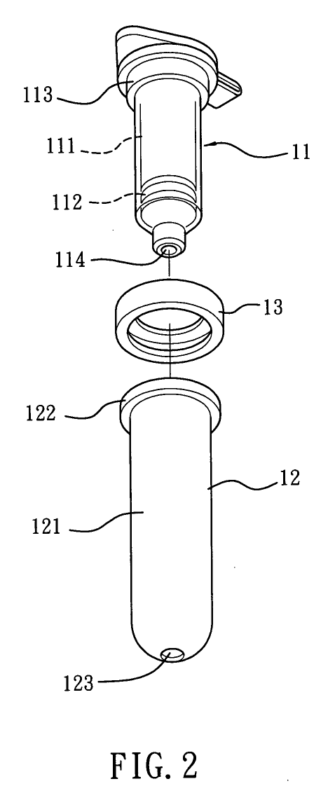

FIG. 2 illustrates a schematic view of a conventional liquid semi-permeable membrane column used in conjunction with a vacuum connected column according to the present invention. Generally the liquid semi-permeable membrane column 11 is of a tubular shape and comprises an inner section, a top section and a bottom section. The inner section defines a first receiving space 111 and at least one liquid semi-permeable membrane 112 is placed at the bottom of the first receiving space 111. The top section is formed with a first aperture (not shown in figure) and a first protrusion 113 extends outwards from the top section while the bottom section is formed with a first through hole 114.

Generally the vacuum connected column 12 is of a tubular shape and can be made of any suitable material. The vacuum connected column 12 comprises an inner section, a top section and a bottom section. The inner section defines a second receiving space 121. The top section is formed with a second aperture (not shown in figure) and a second protrusion 122 extends outwards from the top section while the bottom section is formed with a second through hole 123. The inner diameter of the vacuum connected column 12 is larger than that of the middle tubular section of the liquid semi-permeable membrane column 11 but is smaller than that of the first protrusion 113 of the liquid semi-permeable membrane column 11 such that when the liquid semi-permeable membrane column 11 is loosely received in the second receiving space 121 of the vacuum connected column 12 through the second aperture, the first protrusion 113 of the liquid semi-permeable membrane column 11 is adapted to abut against the second protrusion 122 of the vacuum connected column 12. Further, an air tight element, preferably an air tight elastic band 13, can be disposed to surround the periphery of the second protrusion 122 of the vacuum connected column 12 to enhance air tightness between the first protrusion 113 and the second protrusion 122.

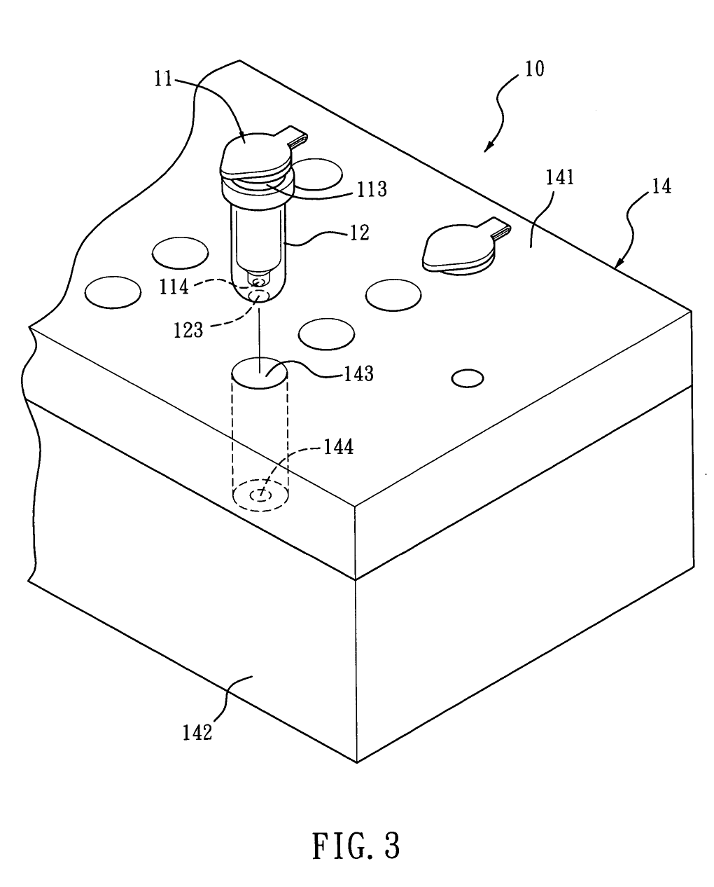

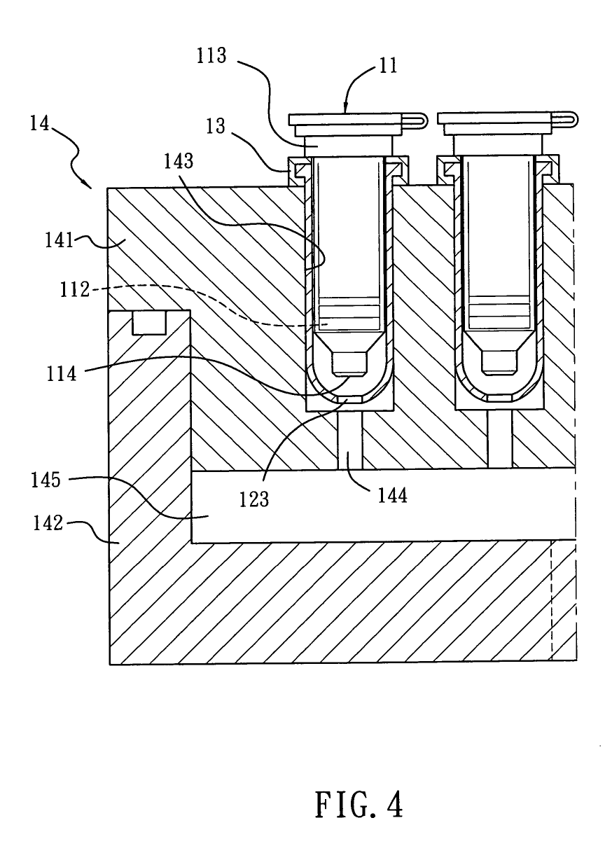

Referring to FIGS. 3 and 4, which illustrate a perspective view of an apparatus 10 for processing biological sample according to the present invention and a cross-sectional view thereof. The apparatus 10 comprises at least one liquid semi-permeable membrane column 11, at least one vacuum connected column 12 and a vacuum manifold 14. The vacuum manifold 14 comprises a lid 141 and a base 142. The base 142 defines a receiving space 145 (referring to FIG. 4). The lid 141 has an upper surface and at least one slot 143 extending downwards therefrom for receiving at least one vacuum connected column 12. The slot 143 has a bottom which is formed with a third through hole 144 which in turn, is in communication with the receiving space 145 of the base 142.

The diameter of the slot 143 is slightly larger than that of the middle tubular section of the vacuum connected column 12 but is smaller than that of the second protrusion 122 of the vacuum connected column 12 such that the vacuum connected column 12 can be loosely received in the slot 143 when the liquid semi-permeable membrane column 11 is received in the vacuum connected column 12. The second protrusion 122 is then adapted to abut against the upper surface of the lid 141 around the edge of the slot 143 and the first, the second and the third through holes 114, 123, 144 are in communication. In addition, any slot 143 which does not receive the vacuum connected column 12 should be air tightened by other suitable means, such as by inserting a conventional collection tube into the slot 143. An air tight element, preferably an air tight elastic band 13, can be disposed to surround the periphery of the second protrusion 122 of vacuum connected column 12. Thereby when the atmospheric pressure in the first receiving space 111 of the liquid semi-permeable membrane column 11 is larger than that in the slot 143 of the vacuum manifold 14, an air tight state is formed and maintained between the first protrusion 113 of the liquid semi-permeable membrane column 11 and the second protrusion 122 of the vacuum connected column 12, and between the second protrusion 122 of the vacuum connected column 12 and the upper surface of the lid 141 around the edge of the slot 143. At the same time the atmospheric pressure is then applied to liquid in the liquid semi-permeable membrane column 11 and pushes the liquid out of the liquid semi-permeable membrane column 11 through the liquid semi-permeable membranes 112 (referring to FIG. 4). The purpose of the vacuum connected columns 12 can not only provide loosely fitting and air tightness effects but also prevents each slot 43 of the vacuum manifold 14 from contacting the different liquid semi-permeable membrane columns 11 with different samples when in repeated operations, which can lead to cross contamination.

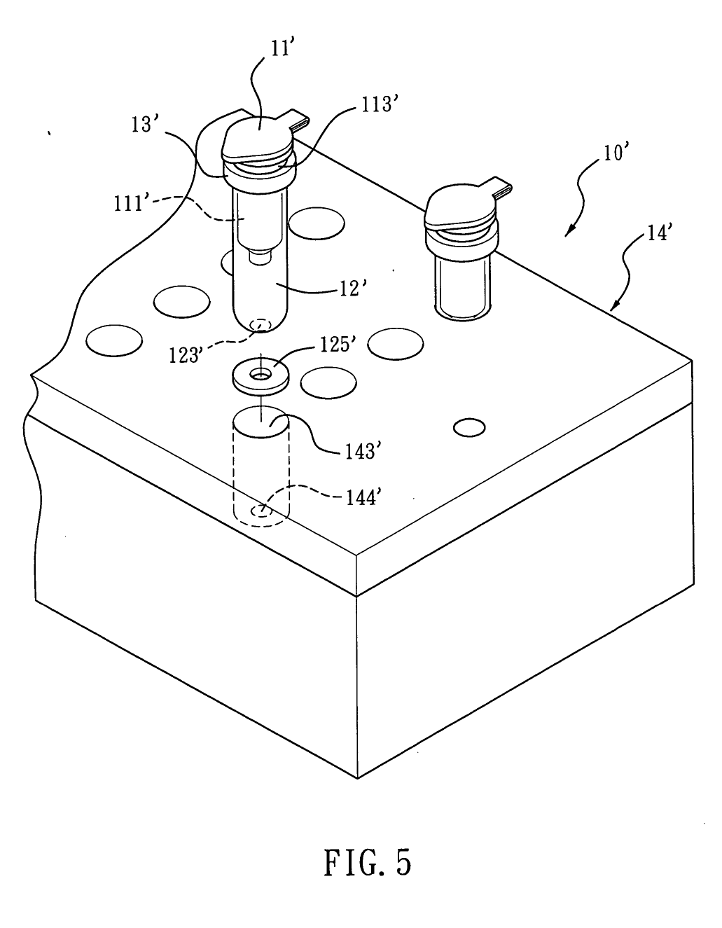

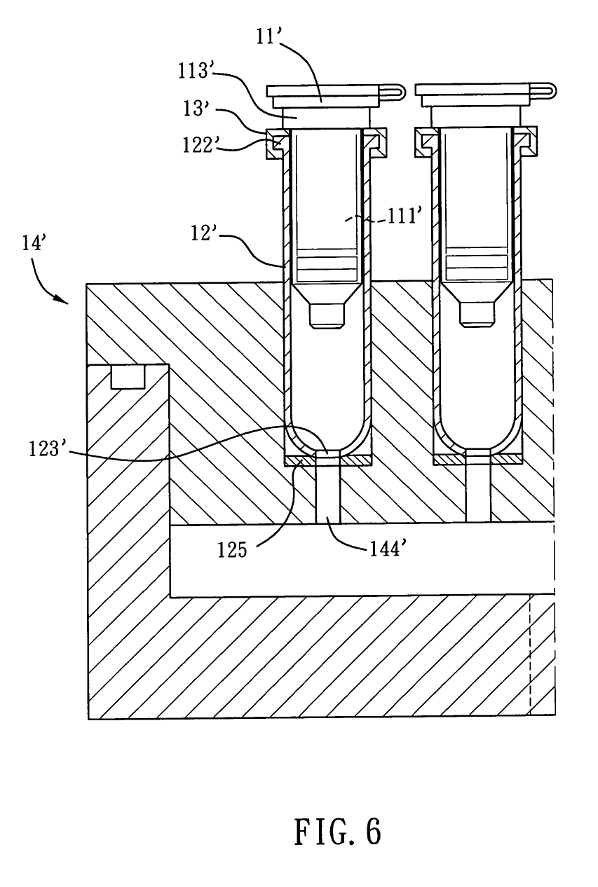

Similarly, when a vacuum connected column 12′ is loosely and partly received in a slot 143′, the air tight engagement between liquid semi-permeable membrane column 11′, the vacuum connected column 12′ and vacuum manifold 14′ is illustrated in FIGS. 5 and 6. An air tight elastic band 125′ is sandwiched between the bottom section of the vacuum connected column 12′ and a bottom of the slot 143′. Thereby when the atmospheric pressure in a first receiving space 111′ of the liquid semi-permeable membrane column 11′ is larger than that in the slot 143′ of the vacuum manifold 14′, an air tight state is maintained between a first protrusion 113′ of the liquid semi-permeable membrane column 11′ and a second protrusion 122′ of the vacuum connected column 12′, and between the bottom section of the vacuum connected column 12′, the air tight elastic band 125′ and the bottom of the slot 143′. An air tight element, preferably an air tight elastic band 13′, can be further disposed to surround the periphery of the second protrusion 122′ of the vacuum connected column 12′ to enhance air tightness between the first protrusion 113′ and the second protrusion 122′.

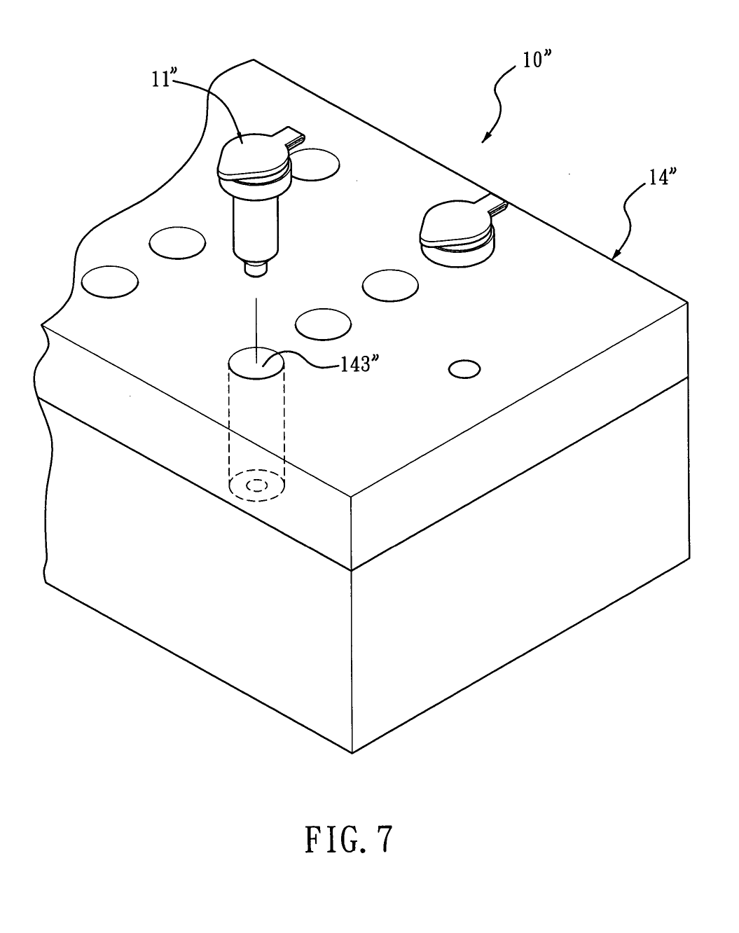

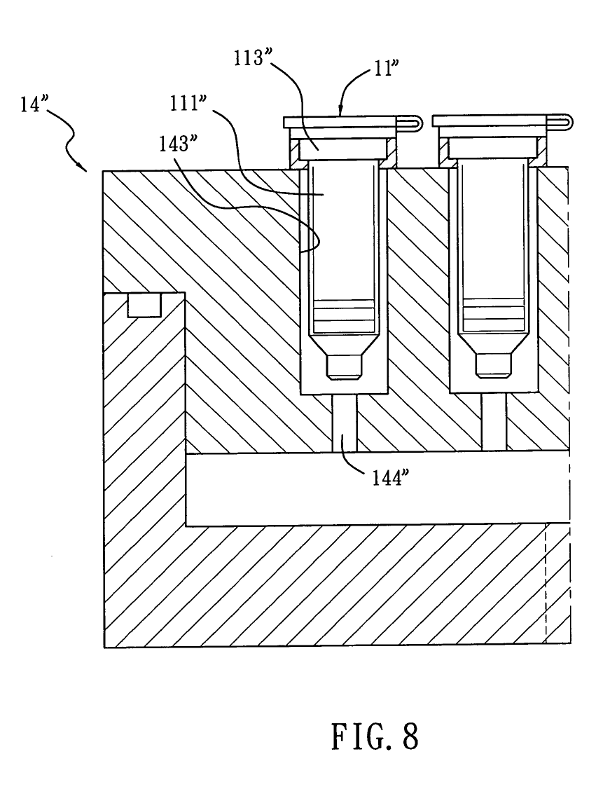

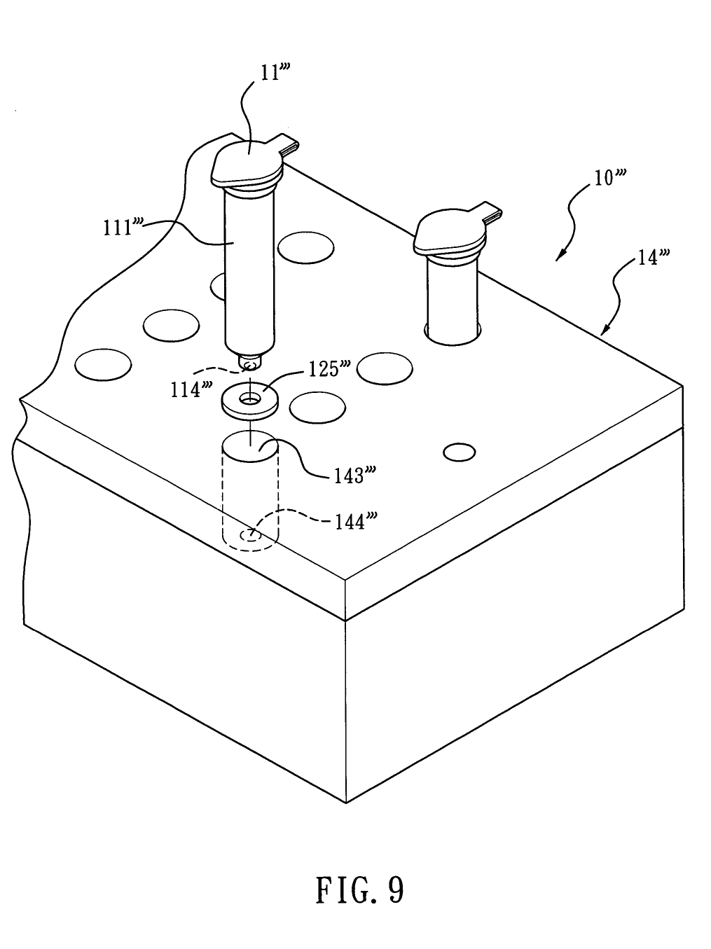

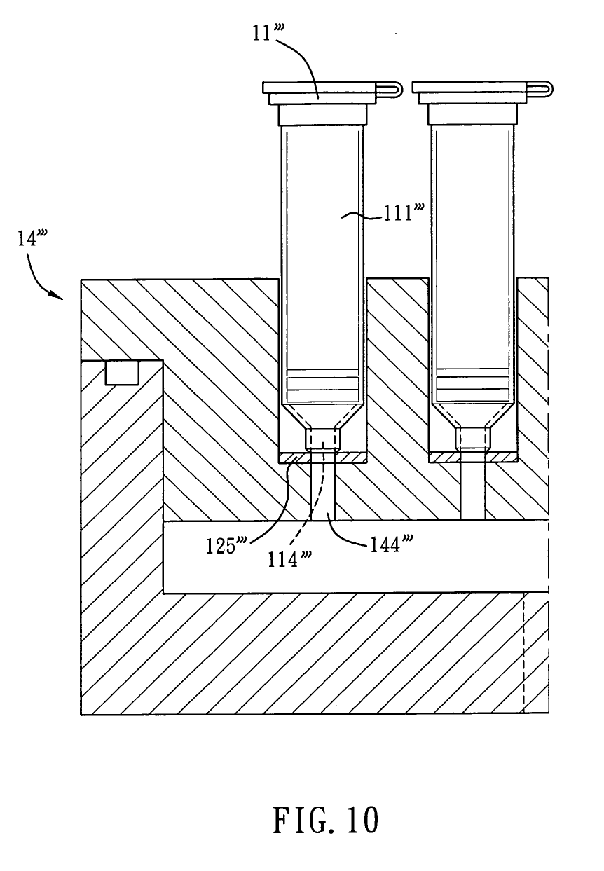

Referring to FIGS. 7 to 10, liquid semi-permeable membrane columns 11″, 11′″ can directly engage vacuum manifolds 14″, 14′″, respectively. Air tight elastic bands 13″, 125′″ can be disposed to surround the periphery of a first protrusion 113″ of the liquid semi-permeable membrane columns 11″, or be sandwiched between the bottom section of the liquid semi-permeable membrane column 11′″ around the periphery of a first through hole 114″ and a bottom of slot 143′″, respectively. Thereby when the atmospheric pressure in a first receiving space 111″ of the liquid semi-permeable membrane column 11″ is larger than that in the slot 143″ of the vacuum manifold 14″, an air tight state is maintained between a first protrusion 113″ of the liquid semi-permeable membrane column 11″ and an upper surface of a lid 141″ around the edge of the slot 143″, or when the atmospheric pressure in a first receiving space 111′″ of liquid semi-permeable membrane column 11′″ is larger than that in a receiving space 145′″ of the base 142′″, an air tight state is maintained between the bottom section of the liquid semi-permeable membrane 11′″ and the bottom of the slot 143′″.

From the above descriptions, it is apparent that the present invention provides an apparatus which is easy to assemble and disassemble, and can overcome the defects in the prior art. Since the liquid semi-permeable membrane column can be easily inserted and pulled out, it can also be operated in an automated process by a mechanical arm. While the invention has been described in terms of several preferred embodiments, those skilled in the art will recognise that the invention can still be practiced with modifications, within the spirit and scope of the appended claims.

What is claimed is:

1. An apparatus for processing biological sample, comprising:
at least one liquid semi-permeable membrane column, comprising:
an inner section defining a first receiving space, the first receiving space having at least one liquid semi-permeable membrane at the bottom thereof;
a top section formed with a first aperture and a first protrusion extending outwards from the top section; and
a bottom section formed with a first through hole; at least one vacuum connected column, comprising:
an inner section defining a second receiving space;
a top section formed with a second aperture and a second protrusion extending outwards from the top section; and
a bottom section formed with a second through hole; and
a vacuum manifold, comprising:
a base defining a receiving space; and
a lid having at least one slot extending downwards therefrom for receiving at least one vacuum connected column, the at least one slot formed with a third through hole in communication with the receiving space of the base;
characterised in that:
the liquid semi-permeable membrane column is loosely received in the second receiving space of the vacuum connected column such that the first protrusion of liquid semi-permeable membrane column abuts against the second protrusion of the vacuum connected column; an air tight element is disposed around the periphery of the second protrusion; the vacuum connected column is loosely received in the slot such that the second protrusion abuts against an upper surface of the lid around the edge of the slot, and the first, the second and the third through holes are in communication; thereby when the atmospheric pressure in the first receiving space of the liquid semi-permeable membrane column is larger than that in the slot of the vacuum manifold, an air tight state is formed and maintained between the first protrusion of the liquid semi-permeable membrane column and the second protrusion of the vacuum connected column, and between the second protrusion of the vacuum connected column and the upper surface of the lid around the edge of the slot.

2. The apparatus according to claim 1, wherein the air tight element is an air tight elastic band.

3. A vacuum connected column for the apparatus according to claim 1, comprising:
an inner section defining a receiving space;
a top section formed with an aperture and a protrusion extending outwards from the top section;
an air tight element disposed around the periphery of the protrusion; and
a bottom section formed with a through hole.

4. An apparatus for processing biological sample, comprising:
at least one liquid semi-permeable membrane column, comprising:
an inner section defining a first receiving space, the first receiving space having at least one liquid semi-permeable membrane at the bottom thereof;
a top section formed with a first aperture and a first protrusion extending outwards from the top section; and
a bottom section formed with a first through hole;
at least one vacuum connected column, comprising:
an inner section defining a second receiving space;
a top section formed with a second aperture and a second protrusion extending outwards from the top section; and
a bottom section formed with a second through hole; and
a vacuum manifold, comprising:
a base defining a receiving space; and
a lid having at least one slot extending downwards therefrom for receiving at least one vacuum connected column, the at least one slot formed with a third through hole in communication with the receiving space of the base;
characterised in that:
the liquid semi-permeable membrane column is loosely received in the second receiving space of the vacuum connected column such that the first protrusion of the liquid semi-permeable membrane column abuts against the second protrusion of the vacuum connected column; an air tight element is disposed around the periphery of the second protrusion; the vacuum connected column is loosely and partly received in the slot such that the first, the second and the third through holes are in communication; an air tight element is sandwiched between the bottom section of the vacuum connected column and a bottom of the slot; thereby when the atmospheric pressure in the first receiving space of the liquid semi-permeable membrane column is larger than that in the slot of the vacuum manifold, an air tight state is formed and maintained between the first protrusion of the liquid semi-permeable membrane column and the second protrusion of the vacuum connected column, and between the bottom section of the vacuum connected column and the bottom of the slot.

5. The apparatus to claim 4, wherein the air tight element is an air tight elastic band.

6. A vacuum connected column for the apparatus according to claim 4, comprising:
an inner section defining a receiving space;
a top section formed with an aperture and a protrusion extending outwards from the top section;
an air tight element disposed around the periphery of the protrusion; and
a bottom section formed with a through hole.

7. An apparatus for processing biological sample, comprising:
at least one liquid semi-permeable membrane column, comprising:
an inner section defining a first receiving space, the first receiving space having at least one liquid semi-permeable membrane at the bottom thereof;
a top section formed with a first aperture and a first protrusion extending outwards from the top section; and
a bottom section formed with a first through hole; and
a vacuum manifold, comprising:
a base defining a receiving space; and
a lid having at least one slot extending downwards therefrom for receiving at least one liquid semi-permeable membrane column, the at least one slot formed with a second through hole in communication with the receiving space of the base;
characterised in that:
the liquid semi-permeable membrane column is loosely received in the slot such that the first protrusion of the liquid semi-permeable membrane column abuts against an upper surface of the lid around the edge of the slot, and the first and the second through holes are in communication; an air tight element is disposed around the periphery of the first protrusion; thereby when the atmospheric pressure in the first receiving space of the liquid semi-permeable membrane column is larger than that in the slot of the vacuum manifold, an air tight state is formed and maintained between the first protrusion of the liquid semi-permeable membrane column and the upper surface of the lid around the edge of the slot.

8. The apparatus to claim 7, wherein the air tight element is an air tight elastic band.

9. An apparatus for processing biological sample, comprising:
at least one liquid semi-permeable membrane column, comprising:
an inner section defining a first receiving space, the first receiving space having at least one liquid semi-permeable membrane at the bottom thereof;
a top section formed with a first aperture and a first protrusion extending outwards from the top section; and
a bottom section formed with a first through hole; and
a vacuum manifold, comprising:
a base defining a receiving space; and
a lid having at least one slot extending downwards therefrom for receiving at least one liquid semi-permeable membrane column, the at least one slot formed with a second through hole in communication with the receiving space of the base;
characterised in that:
the liquid semi-permeable membrane column is loosely and partly received in the slot; an air tight element is sandwiched between the bottom section of the liquid semi-permeable membrane column and a bottom of the slot such that the first and the second through holes are in communication; thereby when the atmospheric pressure in the first receiving space of the liquid semi-permeable membrane column is larger than that in the receiving space of the base, an air tight state is formed and maintained between the bottom section of the liquid semi-permeable membrane and the bottom of the slot.

10. The apparatus to claim 9, wherein the air tight element is an air tight elastic band.
